(19) United States
(12) Patent Application Publication
(10) Pub. No.: US 2002/0154364 A1
(43) Pub. Date: Oct. 24, 2002

(54) Signalling system

(76) Inventors: Alan Edward Green, Cambridgeshire (GB); Euan Morrison, Cambridgeshire (GB)

Correspondence Address: Finnegan, Henderson, Farabow,, Garrett & Dunner, L.L.P., 1300 I Street, N.W, Washington, DC, 20005-3315, US

(21) Appl. No.: 10/038,576

(22) Filed: Jan. 8, 2002

Related U.S. Application Data
(63) Continuation-in-part of application No. PCT/GB00/02632, filed on Jul. 10, 2000.

(30) Foreign Application Priority Data
Jul. 8, 1999 (GB) 9916083.0
Jul. 8, 1999 (GB) 9916084.8
Jul. 8, 1999 (GB) 9916085.5
Jul. 8, 1999 (GB) 9916086.3

(51) Int. Cl. H04B 10/00; H04B 10/04

(52) U.S. Cl. 359/172; 359/181

(57) ABSTRACT

An optical communications system is provided comprising first and second signalling devices in which a duplex communications link between the signalling devices can be established. The first signalling device includes a retro-reflector and the second signalling device includes at least one light source for directing light towards the retro-reflector. Half-duplex embodiments and full-duplex embodiments are described. A wave division multiplex retro-reflecting communication system is also described.

The present invention relates to a signalling system. The invention has particular, although not exclusive, relevance to the provision of a duplex free space optical communication system.

The applicant has proposed in their earlier International Application WO 98/35328 a point to multipoint data transmission system which uses a retro-reflector to receive collimated laser beams from a plurality of user terminals, to modulate the received laser beams and to reflect them back to the respective user terminals. This point to multipoint data transmission system employs pixelated reflector/modulator arrays and a telecentric optical lens system. Each pixel in the array maps to a unique angular position in the field of view of the telecentric optical lens system. Communications with each of the user terminals is then achieved using the appropriate pixel in the array which maps to the direction in which the user terminal is located within the field of view.

WO 98/35328 teaches the use of an array of Quantum Confined Stark Effect (QCSE) modulators and a separate array of photodiodes. This earlier application also teaches that the photodiodes and the modulators may be provided in a single array. WO 98/35328 also teaches that a low. bandwidth control channel may be established between the rectro-reflector and the user terminals by adding a small signal modulation to the laser beam transmitted from the user terminals. However, this results in asymmetric bandwidths for the uplink data and the downlink data.

According to one aspect, the invention aims to provide an optical free space communication system having an increased uplink bandwidth for data transmitted from the user terminal to the retro-reflector. According to another aspect, the invention aims to provide an increased bandwidth for downlink data transmitted from the retro-reflector to the user terminal. According to another aspect, the invention provides a full duplex free space optical communication system having symmetrical bandwidth available for the uplink and downlink data. According to another aspect, the invention aims to simplify the system described in WO 98/35328.

Exemplary embodiments of the inventions will now be described with reference to the accompanying drawings in which:

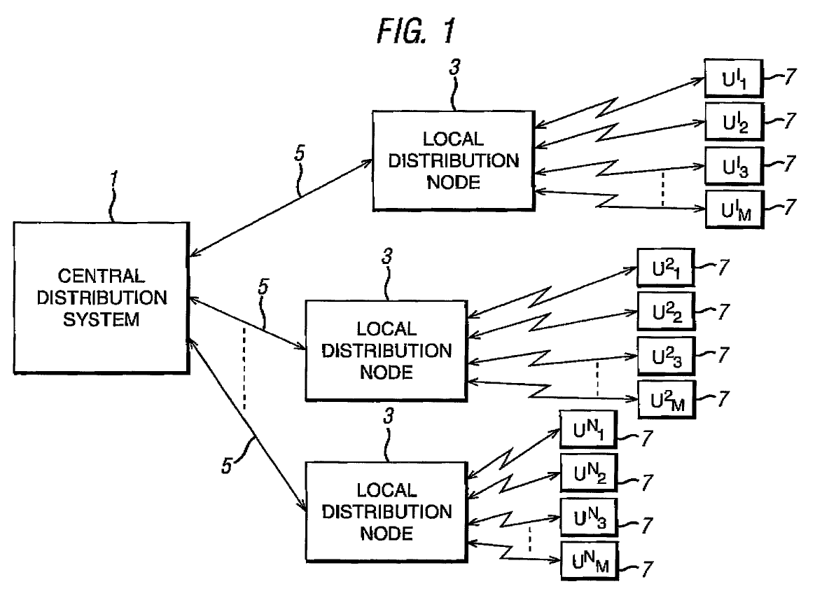

FIG. 1 is a schematic diagram of a video broadcast system for supplying video signals for a plurality of television channels, to a plurality of remote users;

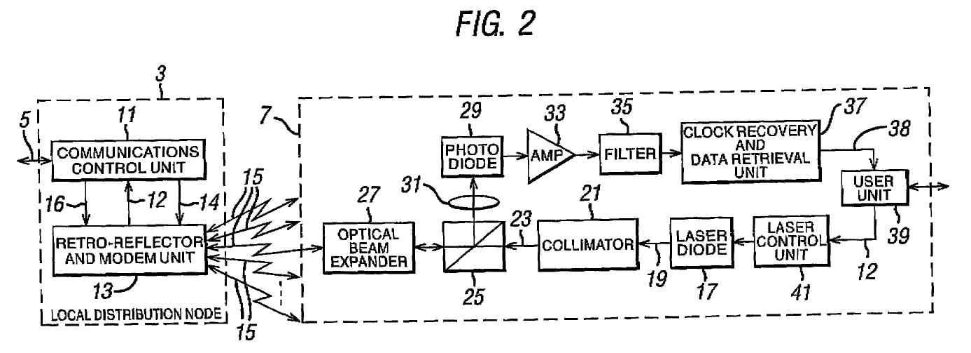

FIG. 2 is a schematic block diagram of a local distribution node and a user terminal which forms part of the video broadcast system shown in FIG. 1;

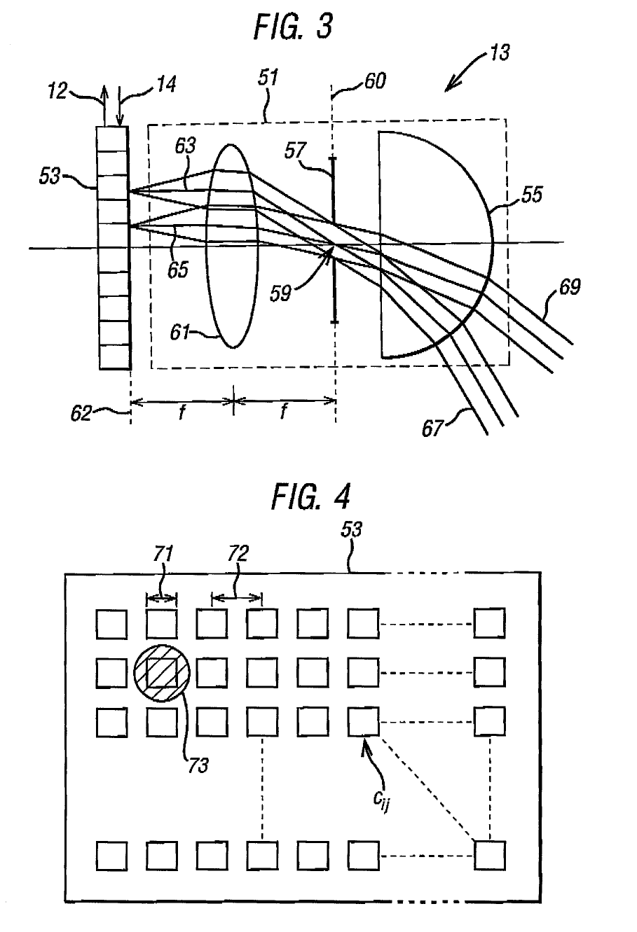

FIG. 3 is schematic diagram of a retro-reflector array and lens system employed in the local distribution node shown in FIG. 2;

FIG. 4 is a schematic diagram of a pixelated modulator array forming part of the retro-reflector array and lens system shown in FIG. 3;

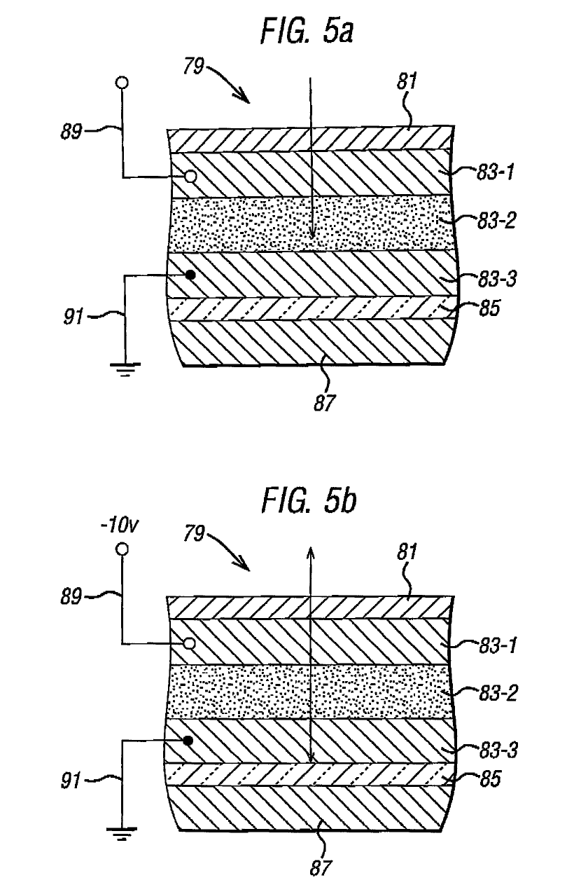

FIG. 5a is a cross-sectional view of one modulator of the pixelated modulator shown in FIG. 4, in a first operational mode when no DC bias is applied to electrodes thereof;

FIG. 5b is a cross-sectional view of the modulator shown in FIG. 5a, in a second operational mode when a bias voltage is applied to the electrode;

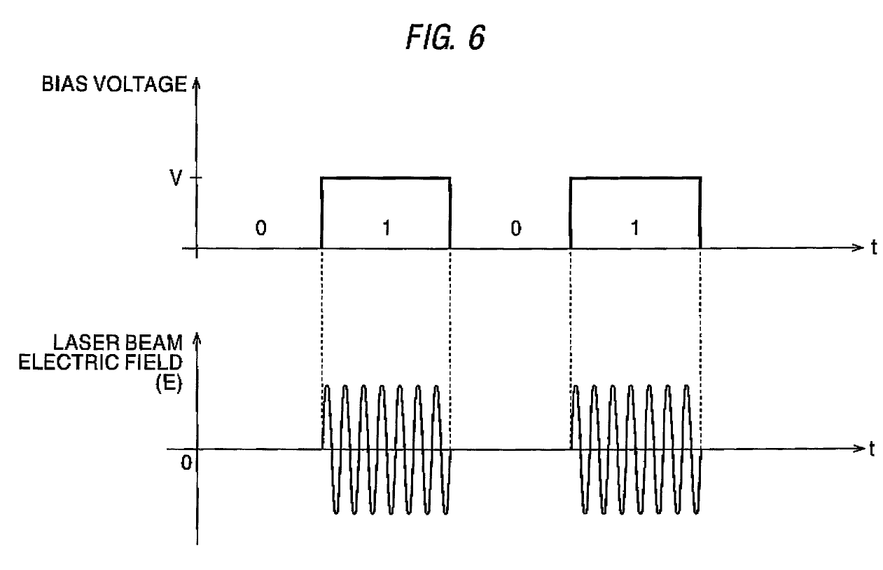

FIG. 6 is a signal diagram which illustrates the way in which light incident on the modulators shown in FIG. 5 is modulated in dependence upon the bias voltage applied to the modulator electrodes;

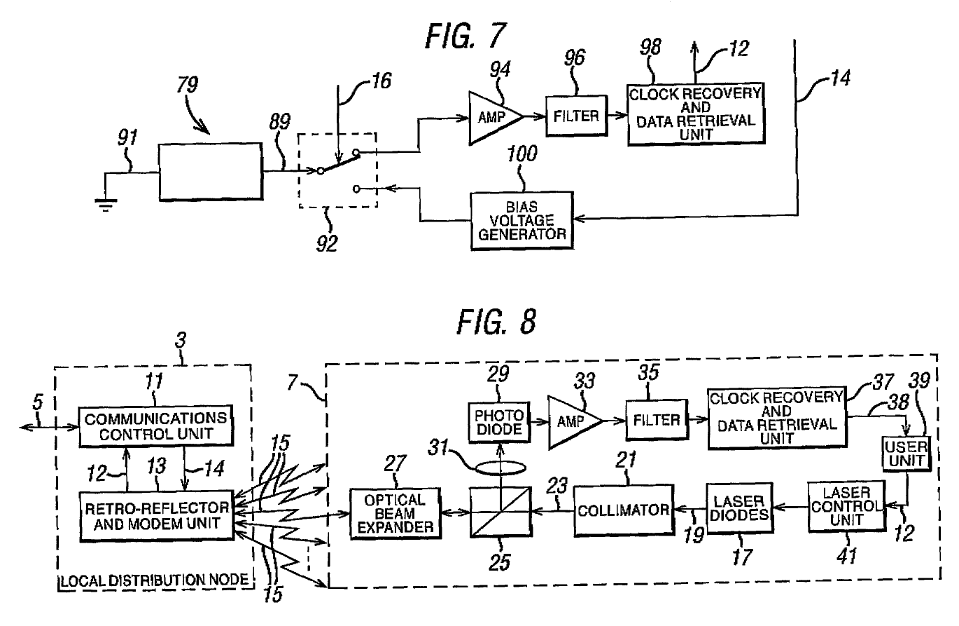

FIG. 7 is a block diagram illustrating the principal components of the bias voltage driving circuitry and the detection circuitry which is coupled to the electrodes of the modulator shown in FIG. 5;

FIG. 8 is a schematic diagram of a local distribution node and a user terminal which forms part of a data distribution system similar to that shown in FIG. 1;

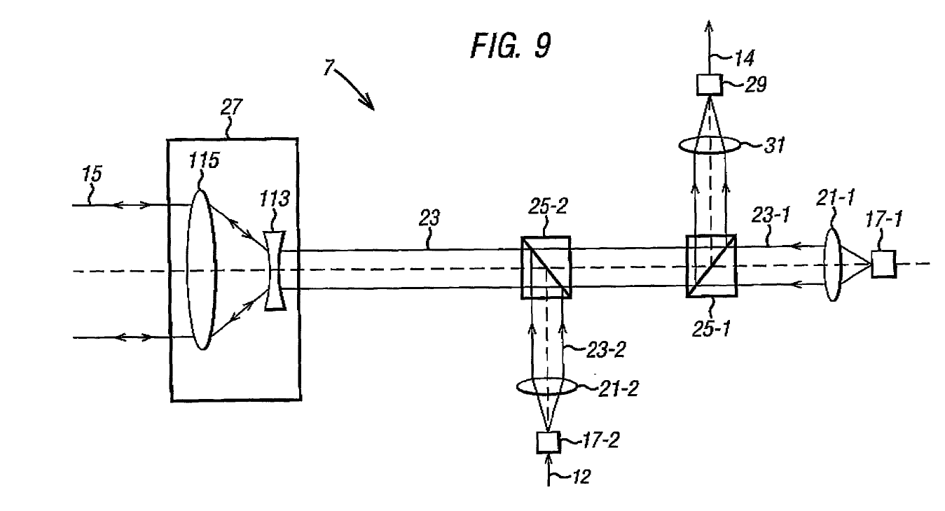

FIG. 9 is a schematic diagram of the main optical components of the user terminal shown in FIG. 8;

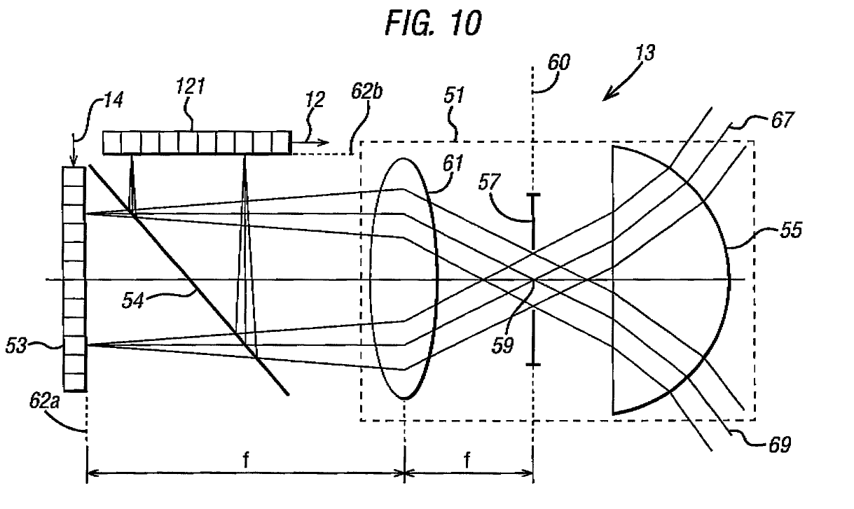

FIG. 10 is a schematic view of the local distribution node shown in FIG. 8;

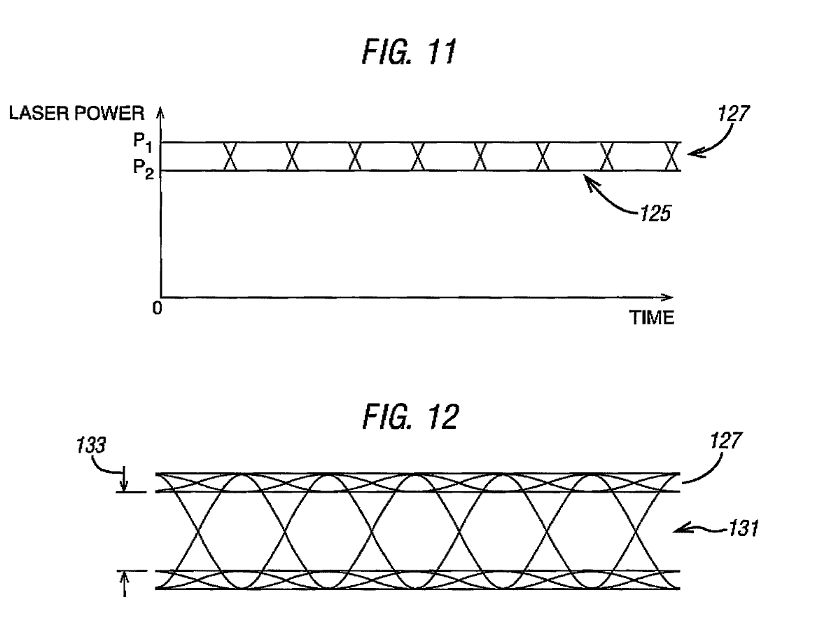

FIG. 11 is a plot illustrating the way in which the laser power is varied to achieve a small signal modulation for uplink data transmitted from a user terminal to a local distribution node;

FIG. 12 is an eye diagram illustrating the effect of the small signal modulation on the downlink data transmitted from the local distribution node to the user terminal;

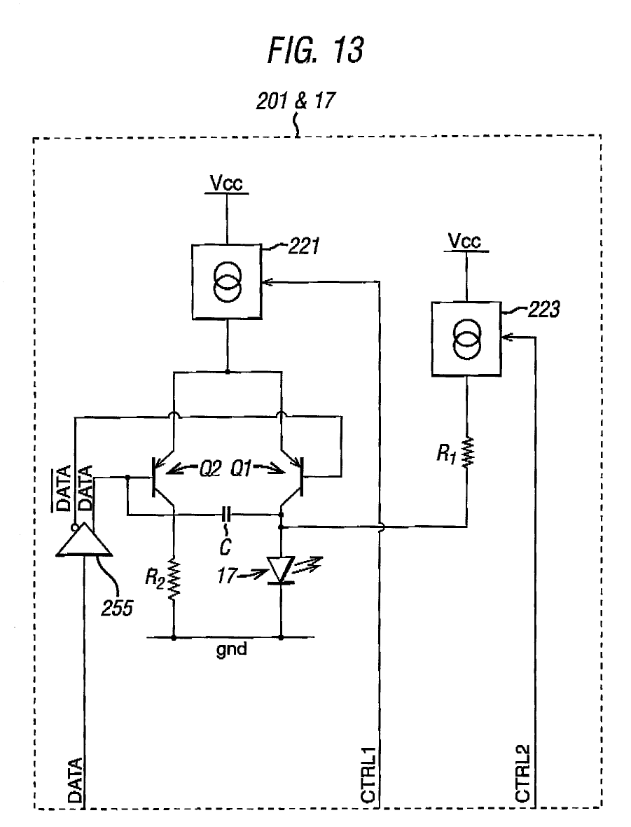

FIG. 13 is a circuit diagram illustrating the main components of a laser driver forming part of a user terminal shown in FIG. 2;

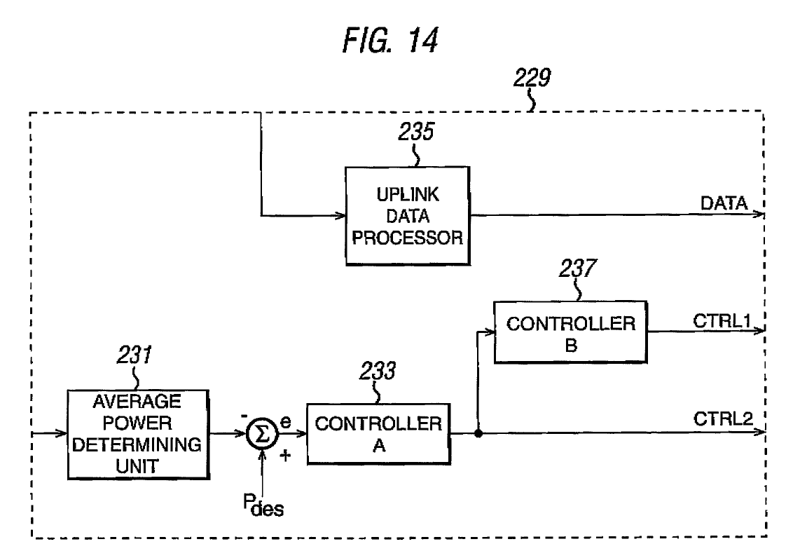

FIG. 14 is a block diagram illustrating the main components of a laser control unit forming part of the user terminal shown in FIG. 2;

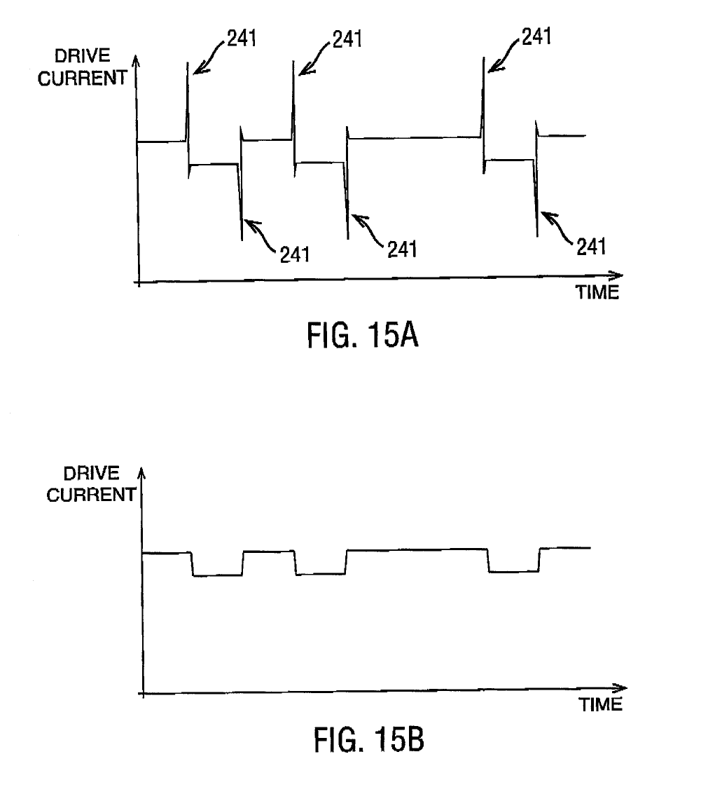

FIG. 15A is a plot showing the way in which the drive current applied to the laser diode shown in FIG. 2 varies using a conventional laser driver;

FIG. 15B is a plot of the drive current generated using the laser driver shown in FIG. 13;

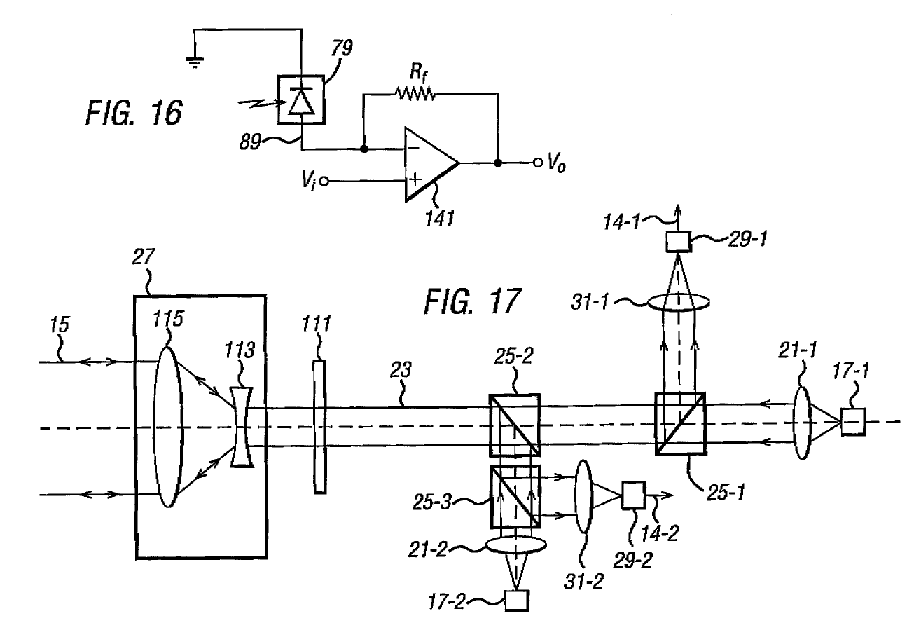

FIG. 16 is a schematic circuit diagram illustrating the way in which the modulator shown in FIG. 5 can be operated to modulate a received laser beam with data and to simultaneously detect data carried by the received laser beam;

FIG. 17 is a schematic diagram illustrating the principal components of a user terminal which may be used in a communications system similar to that shown in FIG. 1; and

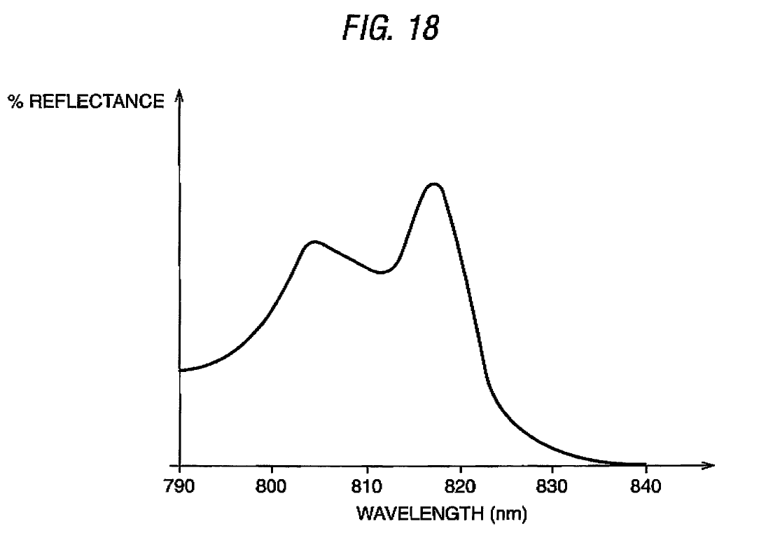

FIG. 18 is plot illustrating the way in which the reflectance of a QCSE modulator varies with the wavelength of the incident light.

FIG. 1 schematically illustrates a video broadcast system for supplying video signals, for a plurality of television channels, to a plurality of remote users. As shown in FIG. 1, the system comprises a central distribution system 1 which transmits optical video signals to a plurality of local distribution nodes 3 via a bundle of optical fibres 5. The local distribution nodes 3 are arranged to receive the optical video signals transmitted from the central distribution system 1 and to transmit relevant parts of the video signals to respective user terminals 7 (which are spatially fixed relative to the local distribution node 3) as optical signals through free space, i.e. not as optical signals along an optical fibre path.

In this embodiment, the video data for all the available television channels is transmitted from the central distribution system 1 to each of the local distribution nodes 3, each user terminal 7 informs the appropriate local distribution node 3 which channel or channels it wishes to receive (by transmitting an appropriate request) and, in response, the local distribution node 3 transmits the appropriate video data, to the respective user terminals 7. Each local distribution node 3 does note however, broadcast the video data to the respective user terminals 7. Instead, each local distribution node 3 is arranged (i) to receive an optical beam transmitted from each of the user terminals 7 which are in its locality, (ii) to modulate the received beams with the appropriate video data for the desired channel or channels, and (iii) to reflect the modulated beams back to the respective user terminals 7. In addition to being able to receive optical signals from the central distribution system 1 and from the user terminal 7, each of the local distribution nodes 3 can also transmit optical data, such as status reports, back to the central distribution system 1 via the respective optical fibre bundle 5, so that the central distribution system 1 can monitor the status of the distribution network.

FIG. 2 schematically illustrates in more detail the main components of one of the local distribution nodes 3 and one of the user terminals 7 of the system shown in FIG. 1. As shown in FIG. 2, the local distribution node 3 comprises a communications control unit 11 which (i) receives the optical signals transmitted along the optical fibre bundle 5 from the central distribution system 1; (ii) regenerates the video data from the received optical signals; (iii) receives messages 12 transmitted from the user terminals 7 and takes appropriate action in response thereto; and (iv) converts the appropriate video data into data 14 for modulating the respective light beams 15 received from the user terminals 7. In converting the video data into modulation data 14, the communications control unit 11 will encode the video data with error correction coding and coding to reduce the effects of inter-symbol-interference and other kinds of well known sources of interference such as from the sun and other light sources.

The local distribution node 3 also comprises a retro-reflector and modem unit 13, which is arranged to receive the optical beams 15 from the user terminals 7 which are within its field of view, to modulate the respective light beams with the appropriate modulation data 14 and to reflect the modulated beams back to the respective user terminals 7. In the event that an optical beam 15 received from one of the user terminals 7 carries a message 12, then the retro-reflector and modem unit 13 retrieves the message 12 and sends it to the communications control unit 11 where it is processed and the appropriate action is taken. In this embodiment, the retro-reflector and modem unit 13 has a horizontal field of view which is greater than +/−50° and a vertical field of view of approximately +/−5°.

FIG. 2 also shows the main components of one of the user terminals 7. As shown, the user terminal 7 comprises a laser diode 17 for outputting a laser beam 19 of coherent light. In this embodiment, the user terminals 7 are designed so that they can communicate with the local distribution node 3 within a range of 150 meters with a link availability of 99.9 percent. To achieve this, the laser diode 17 is a 50 mW laser diode which outputs a laser beam having a wavelength of 850 nm. This output laser beam 19 is passed through a collimator 21 which reduces the angle of divergence of the laser beam 19. The resulting laser beam 23 is passed through a beam splitter 25 to an optical beam expander 27, which increases the diameter of the laser beam for transmittal to the retro-reflector and modem unit 13 located in the local distribution node 3. The optical beam expander 27 is used because a large diameter laser beam has a smaller divergence than a small diameter laser beam. Additionally, increasing the diameter of the laser beam also has the advantage of spreading the power of the laser beam over a larger area. Therefore, it is possible to use a higher powered laser diode 17 whilst still meeting eye-safety requirements.

Using the optical beam expander 27 has the further advantage that it provides a fairly large collecting aperture for the reflected laser beam and it concentrates the reflected laser beam into a smaller diameter beam. The smaller diameter reflected beam is then split from the path of the originally transmitted laser beam by the beam splitter 25 and focussed onto a photo-diode 29 by a lens 31. Since the operating wavelength of the laser diode 17 is 850 nm, a silicon avalanche photo-diode (APD) can be used, which is generally more sensitive than other commercially available photo detectors, because of the low noise multiplication which can be achieved with these devices. The electrical signals output by the photodiode 29, which will vary in dependence upon the modulation data 14, are then amplified by the amplifier 33 and filtered by the filter 35. The filtered signals are then supplied to a clock recovery and data retrieval unit 37 which regenerates the clock and the video data using standard data processing techniques. The retrieved video data 38 is then passed to the user unit 39, which, in this embodiment, comprises a television receiver in which the video data is displayed to the user on a CRT (not shown).

In this embodiment, the user unit 39 can receive an input from the user, for example indicating the selection of a desired television channel, via a remote control unit (not shown). In response, the user unit 39 generates an appropriate message 12 for transmittal to the local distribution node 3. This message 12 is output to a laser control unit 41 which controls the laser diode 17 so as to cause the laser beam 19 output from the laser diode 17 to be modulated with the message 12. As those skilled in art will appreciate, in order that the data being transmitted in opposite directions do not interfere with each other, different modulation techniques should be employed. For example, if the amplitude of the laser beam 15 is modulated by the local distribution node 3, then the laser control unit 41 should modulate, for example, the phase of the transmitted laser beam. Alternatively, the laser control unit 41 could apply a small signal modulation to the laser beam 19 to create a low-bandwidth control channel between the user terminal 7 and the local distribution node 3. This is possible provided the detector in the local distribution node 3 can detect the small variation in the amplitude of the received laser beam. Furthermore, such a small signal amplitude modulation of the laser beam would not affect a binary “on” and “off” type modulation which could be employed by the retro-reflector and modem unit 13.

The structure and function of the components in the user terminal 7 are well known to those skilled in the art and a more detailed description of them shall, therefore, be omitted.

FIG. 3 schematically illustrates the retro-reflector and modem unit 13 which forms part of the local distribution node 3 shown in FIG. 2. As shown, in this embodiment, the retro-reflector and modem unit 13 comprises a wide angle telecentric lens system 51 and an array of modulators/detectors 53. The design of such a wide angle telecentric lens using fisheye lens techniques is well known to those skilled in the art. In this embodiment, the telecentric lens 51 comprises lens elements 51 and 55 and a stop member 57, having a central aperture 59. The size of the aperture 59 is a design choice and depends upon the particular requirements of the installation. The structure and function of the telecentric lens system is described in the applicants earlier International application WO 98/35328, the contents of which are incorporated herein by reference.

As illustrated in FIG. 3 by the two sets of ray bundles 67 and 69, laser beams form different sources are focussed onto different parts of the array of modulators/detectors 53. Therefore, by using an array of separate modulators/detectors 53, the laser beams 15 from all the user terminals 7 can be separately detected and modulated by a respective modulator/detector. FIG. 4 is a schematic representation of the front surface (i.e. the surface facing the lens system 51) of the modulator/detector array 53 which, in this embodiment, comprises 100 columns and 10 rows of modulator/detector cells Cᵢⱼ (not all of which are shown in the Figure). In this embodiment, the size of the cells cᵢⱼ is between 50 and 200 μm with a spacing (centre to centre) 72 between the cells being slightly greater than the cell size 71.

The telecentric lens 51 is designed so that the spot size of a focussed laser beam from one of the user terminals 7 corresponds with the size 71 of one of the modulator/detector cells cᵢⱼ, as illustrated by the shaded circle 73 shown in FIG. 4, which covers the modulator/detector cell c₂₂. In this embodiment, Quantum Confined Stark Effect (QCSE), sometimes also referred to as Self Electro-optic Effect Devices or SEEDS) devices, developed by the American Telephone and Telegraphic Company (AT&T), are used for the modulator/detector cells cᵢⱼ. In particular, the QCSE devices are used to both modulate the incident laser beam and to detect the received laser beam. In the applicants earlier International application WO 98/35328 QCSE devices were used only to modulate the received light beam. Separate photodiodes were used to detect the received laser beam. However, this embodiment makes use of the fact that the OCSE modulator device comprises a p-i-n diode and therefore can also detect light incident on it. As will be described in more detail below, in this embodiment, half-duplex communications links between the local distribution nodes and the user terminals are established using the QCSE modulators.

FIG. 5a schematically illustrates the cross-section of the QCSE device 79. As shown, the OCSE device comprises a transparent window 81 through which the laser beam 15 from the appropriate user terminal 7 can pass followed by three layers 83-1, 83-2 and 83-3 of Gallium Arsenide (GaAs) based material. Layer 83-1 is a p conductivity type layer, layer 83-2 is an intrinsic layer and layer 83-3 is an n conductivity type layer. Together, the three layers 83-1, 83-2 and 83-3 form a p-i-n diode. As shown, the p conductivity type layer 83-1 is connected to the electrode 89 and the n conductivity type layer 83-3 is connected to the ground terminal 91. As shown in FIG. 5a, a reflective layer 85 is provided beneath the n type conductivity layer 83-3 and beneath this a substrate layer 87.

In operation, the laser beam 15 from the user terminal 7 passes through the window 81 into the gallium arsenide based layers 83. Depending upon DC bias voltage applied to the electrode 89, the laser beam 15 is either reflected by the reflective layer 85 or it is absorbed in the intrinsic layer 83-2. In particular, when no DC bias is applied to the electrode 89, as illustrated in FIG. 5a, the laser beam 15 passes through the window 81 and is absorbed within the intrinsic layer 83-2. Consequently, when there is no DC Bias voltage applied to the electrode 89, no light is reflected back to the corresponding user terminal 7. On the other hand, when a DC bias voltage of approximately −10 volts is applied to the electrode 89, as illustrated in FIG. 5b, the laser beam from the corresponding user terminal 7 passes through the window 81 and is reflected by the reflecting layer 85 back upon itself along the same path to the corresponding user terminal 7.

Therefore, by changing the bias voltage applied to the electrode 89 in accordance with the modulation data to be transmitted to the user terminal 7, the QCSE modulator 79 will amplitude modulate the received laser beam 15 and reflect the modulated beam back to the user terminal 7. In particular, as illustrated in FIG. 6, for a binary zero to be transmitted, a zero voltage bias is applied to the electrode 89, resulting in no reflected light and for a binary one to be transmitted a DC bias voltage of −10 volts is applied to the electrode 89, resulting in the laser beam 15 being reflected back from the device 79 to the corresponding user terminal 7. Therefore, the light beam which is reflected back to the user terminal 7 is, in effect being switched on and off in accordance with the modulation data 14. Therefore, by monitoring the amplitude of the signal output by the photodiode 29 shown in FIG. 2, the corresponding user terminal 7 can detect and recover the modulation data 14 and hence the corresponding video data.

Ideally, the light which is incident on the QCSE device 79 is either totally absorbed therein or totally reflected thereby. In practice, however, the OCSE device 79 will reflect typically 5% of the laser beam 15 when no DC bias is applied to the electrode 89 and between 20% and 30% of the laser beam 15 when the DC bias is applied to the electrode 89. Therefore, in practice, there will only be a difference of about 15% to 25% in the amount of light which is directed on to the photodiode 29 when a binary zero is being transmitted and when a binary one is being transmitted.

By using the QCSE device 79, modulation rates of the individual cells as high as two Giga bits per second can be achieved. This is more than enough to be able to transmit the video data for the desired channel or channels to the user terminal 7 together with the appropriate error correcting coding and other coding which may employed to facilitate the recovery of the data clock.

When operating as a photo detector, a signal will be generated at the electrode 89 in response to the incident laser beam. Therefore, by passing this signal through appropriate detection circuitry, the data 12 transmitted from the user terminal 7 can be regenerated.

As mentioned above, in this embodiment, a half duplex communication link is established between the local distribution nodes 3 and the user terminals 7. Therefore, data is only transmitted in one direction at any one time. FIG. 7 is circuit diagram illustrating the drive circuitry and detection circuitry which is connected to the QCSE device 79 via electrode 89 and switch 92. As shown, the position of the switch 92 is controlled by a control signal 16 generated by the communications control unit 11 (shown in FIG. 2). When the switch is in the position shown in FIG. 7, the laser beam transmitted from the user terminal 7 to the local distribution node 3 is detected by the QCSE device 79 and a corresponding electrical signal is output from the electrode 89. As shown, this signal is amplified by the amplifier 94 and then filtered by the filter 96. The filtered signal is then applied to a clock recovery and data retrieval unit 98 which regenerates the clock and the data transmitted from the user terminal using standard data processing techniques. The retrieved data 12 is then passed to the communications control unit 11 which takes the appropriate action. When video data is to be transmitted from the local distribution node 3 to the user terminal 7, the switch 92 is switched to the other position so that the bias voltage generator 100 is connected to the electrode 89 of the QCSE device 79. The bias voltage generator 100 applies the appropriate bias voltage to the QCSE device 79 in accordance with the received modulation data 14, in the manner described above.

By time sharing the operation of the QCSE device 79 in this way, the full bandwidth of the communication link between the local distribution node 3 and the user terminals 7 is available for both uplink and downlink data. However, with the video distribution system of the present embodiment, since more data needs to be transmitted from the local distribution nodes 3 to the user terminal 7, the system will spend most of the time operating with the switch 92 connecting the bias voltage generator 100 to the QCSE device 79.

In the embodiment described above, a single laser beam is transmitted between each user terminal 7 and a local distribution node 3, with the modulation of the laser beam being time shared for both the uplink and downlink data. In this way, half-duplex communication links between the user terminals 7 and the local distribution nodes 3 are established. An embodiment will now be described with reference to FIGS. 8 to 11 in which full-duplex communication links are established between the local distribution nodes 3 and the user terminals 7. In this embodiment, this achieved by providing two laser diodes in the user terminal 7 which share the same communications channel but which operate with different polarisations.

FIG. 8 schematically illustrates in more detail the main components of one of the local distribution nodes 3 and one of the user terminals 7 used in this embodiment. As shown in FIG. 8, the local distribution node includes a local distribution communications unit 11 similar to that of the first embodiment together with a retro-reflector and modem unit 13 which is also similar to that of the first embodiment. The user terminal 7 is also similar to the user terminal of the first embodiment except that two laser diodes 17 are provided. FIG. 9 shows in more detail the main optical components of the user terminal 7. As shown, the user terminal 7 includes two laser diodes 17-1 and 17-2 which are orientated relative to each other so that their polarisations are orthogonal. (Alternatively, the two lasers may be mounted in the same orientation, with a 90° rotation of the polarisation being applied to one of the laser beams using a half wave retardation plate.) The laser beam 23-1 generated by the first lager diode 17-1 is collimated by a collimator lens 21-1 and is used to carry the downlink data 14 transmitted from the local distribution node 3 to the user terminal 7. As shown, the collimated beam 23-1 passes through a first beamsplitter 25-1 and then passes through a second beamsplitter 25-2 where it is optically combined with the collimated laser beam 23-2, formed by the collimating lens 21-2 from the laser beam generated by the second laser diode 17-2. In this embodiment, the uplink data 12 transmitted from the user terminal 7 to the local distribution node 3 is modulated onto the second laser beam 23-2. The combined laser beam is then expanded through an optical beam expander 27 comprising a concave lens 113 and a collimating lens 115. The expanded laser beam 15 output by the optical beam expander 27 is directed towards the local distribution node 3.

FIG. 10 is a schematic diagram of the local distribution node of this embodiment. Elements that are common to the local distribution node of the first embodiment have been assigned the same reference numeral. As can be seen from a comparison of FIG. 10 and FIG. 3, the main difference between the local distribution node of this embodiment is the provision of a polarising beamsplitter 54 and a separate array of detectors 121 located on the back focal plane of the telecentric lens 51. The polarising beamsplitter 54 is arranged to split the laser beams from the two sources 17-1 and 17-2 so that the laser beam carrying the uplink data 12 (from the diode 17-2) is directed onto the array of detectors 121 and so that the unmodulated beam (from diode 17-1) is directed onto the array of modulators 53. This is possible because the two laser beams have orthogonal polarisations. The light directed onto the modulator array 53 is then modulated with the downlink modulation data 14 and reflected back to the user terminal 7 in the manner described above. At the user terminal 7, the reflected beam is collected by the beam expander 27 which concentrates the reflected beam into a smaller diameter beam. This concentrated beam then passes back through beamsplitter 25-2 and is reflected by beamsplitter 25-1 towards the lens 31 and the photo-diode 29, which generates a corresponding electrical signal from which the downlink data 14 is retrieved.

In the second embodiment described above, a full duplex communications system is described in which the uplink and the downlink data is transmitted in the same optical channel using laser beams having different polarisation states. As described in the applicants earlier International Application WO98/35328, it is advantageous to convert the transmitted beams to circular polarisation states, as this allows efficient separation of the retro-reflected beam onto the receiver photo-diode 29. In the present embodiment, this provides the additional advantage that the use of circular polarisation removes the need for precise angular alignment of the ends of the link about the optical axis.

Similarly, the uplink and downlink data can be transmitted in the same channel if the two laser beams have different wavelengths instead of or in addition to having different polarisation states. In such an embodiment, the combining and separating optics would comprise dichroic beamsplitters.

The applicants earlier international application WO 98/35328 discloses that a low bandwidth control channel may be established between the rectro-reflector and the user terminals by adding a small signal modulation to the laser beam transmitted from the user terminals. In the type of retro-reflecting system described here, the uplink loss (ie the optical loss from the user terminals to the local distribution nodes) is considerably lower than the downlink loss. This is because the light originates at the user terminals and hence traverses the optical path once for the uplink but twice for the downlink. Further, there are additional losses in the downlink due to, for example, sub-optimal reflectivity of the modulator.

In an optical system, the achievable bit error rate (BER) depends on the signal to noise ratio, which is determined by a number of factors including the path loss, the receiver noise and the modulation depth. Therefore, with a retro-reflecting system, there is “excess” signal to noise ratio available in the uplink, since there is lower path loss. Consequently, the modulation depth in the uplink can be reduced to the point where the uplink modulation is a small signal applied to a large continuous wave (CW) signal. (This is shown in FIG. 11, which shows the CW laser level 125 and the uplink modulation data 127 applied to it which varies between power levels P₁ and P₂.) in other words, because of the asymmetric path loss of a retro-reflecting system, the small signal modulation concept used to provide the low bandwidth control channel discussed above, can be used to provide a “full” bandwidth uplink channel. As those skilled in the art will appreciate, this uplink modulation data will then become an additional noise source for the downlink data. This is illustrated in FIG. 12, which shows an eye diagram for the downlink data 131, which includes the interfering uplink data 127, which reduces the noise margin 133. However, if the uplink modulation depth is kept sufficiently low, then both the uplink and the downlink can operate with equal bandwidth.

FIG. 13 is a circuit diagram illustrating the form of a laser driver 201 used in this embodiment to drive the laser diode 17. As shown, the laser driver 201 includes two current sources 221 and 223 which each provide current for driving the laser diode 17. Current source 223 is a voltage controlled current source which outputs a current in dependence upon a voltage control signal CTRL2 received from a laser control unit 229 (shown in FIG. 14). The current generated by the current source 223 is a bias current and is applied to the laser diode 17 through a resistor R₁. The level of the bias current generated by the current source 223 determines the lower output power level of the laser diode 17 (i.e. P₂ shown in FIG. 11).

The second current source 221 is also a voltage controlled current source whose output current level is determined by a voltage control signal CTRL1 output by the laser control unit 229 (shown in FIG. 14). As shown in FIG. 13, the current output from current source 221 feeds into a differential amplifier formed by two p-n-p transistors Q1 and Q2. As shown, the uplink message (DATA) received from the laser control unit 229 is buffered in a buffer 225 and differential outputs are taken from the buffer 225 and applied to respective bases of the transistors Q1 and Q2. In particular, the base of transistor Q1 is driven with the complement of the uplink message (NOT DATA) and the base of transistor Q2 is driven with the uplink message (DATA). In this way, when the message data has a low value transistor Q1 will be open and transistor Q2 will be closed so that the current generated by the current source 221 passes to ground via the resistor R₂ and, when the message data has a high value, transistor Q2 will be open and transistor Q1 will be closed so that the current generated by the current source 221 passes through the transistor Q1 and adds with the bias current generated by the current source 223 which is then applied to the laser diode 17. As those skilled in the art will appreciate, the amount of current generated by the voltage controlled current source 221 determines the highest output power level of the laser diode 17 (i.e. P₂ shown in FIG. 11).

One feature of the retro-reflecting system of the present embodiment is that the signal strength of the reflected light beam received at the user station 7 is measured and used to control the laser power of the transmitted light beam so that the received signal level is just sufficient to achieve the desired signal-to-noise ratio or bit error rate. In this way, the transmitted light beam power level is set at the lowest level required for system operation, thereby maximising the efficiency of the system and imparting an eye safety benefit.

As those skilled in the art will appreciate, the received signal will include the modulated reflected beam together with background light from the environment (e.g. sunlight). The background light is fairly constant and will form part of the DC component of the received signal. In contrast, the reflected light beam will include both a DC and an AC component due to the amplitude modulation of the reflected beam with the downlink data. In this embodiment, the laser control unit 229 measures the signal strength of the AC signal component of the received signal (in order to avoid false measurements caused by excessive ambient light), and uses this measurement to determine and to output the appropriate voltage control signal CTRL2 for controlling the bias current generated by the current source 223.

The way in which the laser control unit 229 achieves this will now be described with reference to FIG. 14 which shows the main components of the laser control unit 229. As shown, the signal received from the filter 35 is input to an average power determining unit 231. (In this embodiment, the filter 35 is a high pass filter which filters out the DC component but not the AC component of the received signal.) In this embodiment, the average power determining unit 231 determines a running average power of the filtered signal. This measured power level is then subtracted from a desired power level (P_{des}) to generate an error signal (e), which is input to controller A 233 which uses conventional control techniques to vary control signal CTRL2 in order to reduce the error signal (e) to zero. In this embodiment, the desired power level (P_{des}) is set in advance and is determined by parameters of the optical receiver, such as its noise bandwidth, the input current noise and voltage noise spectral densities etc, which are well known parameters for the particular receiver design.

FIG. 14 also shows the uplink data processor 235 which is used to process (encode etc.) the uplink data (DATA) received from the user unit 39, so that it is in a suitable format for transmission to the local distribution node 3. FIG. 14 also shows a second controller (controller B) 237 which generates control signal CTRL1 which is used to control the current source 221 and hence to control the modulation depth of the small signal modulation used to carry the uplink data to the local distribution node 3. As shown in FIG. 14, controller B generates control signal CTRL1 using the control signal CTRL2 as an input. The reason for this will now be described.

As mentioned above, the uplink data is transmitted to the local distribution node 3 by generating a small signal modulation current that is superimposed on the bias current required to provide light for the downlink. The uplink modulation also appears on the retro-reflected downlink signal and is seen as an additional noise source by the user station 7. To minimise the signal-to-noise penalty which the uplink modulation imposes on the downlink signal, it is advantageous to maintain the uplink modulation depth (i.e. P₁−P₂) at a level that is as small as possible whilst maintaining a sufficient uplink signal-to-noise ratio.

In a retro-reflecting system, the downlink signal traverses the atmosphere twice, whilst the uplink signal only traverses the atmosphere once. Therefore, the downlink signal suffers greater atmospheric loss (twice as many dBs) than the uplink signal. Thus, in a simple case, if an increase in atmospheric loss requires that the laser power be increased by xdB to maintain the constant downlink received signal strength, then the uplink modulation depth need only be increased by x/2 dB to maintain the performance of the uplink. In practice, however, the optical system geometrical losses (caused by beam divergence and the size of the system apertures) and the modulation efficiency of the QCSE modulators results in a more complicated relationship between the atmospheric losses and the required uplink modulation depth. The inventors have calculated a power budget for both the uplink and downlink and determined the following relationship that relates the uplink modulation depth to the various losses and receiver sensitivities:

$$10 log [ \frac{{m}_{user}}{1 - {m}_{user}} ] = [ ( {A}_{telecentric} - {A}_{up} ) + ( {A}_{down} + {A}_{atmosphere} ) + ( {S}_{node} - {S}_{user} ) ] + 10 log {m}_{node} \qquad ( 1 )$$

where mᵤₛₑᵣ represents the uplink modulation index which is a number (<1) representing the fraction of the optical power actually modulated, which (referring to FIG. 11) is given by:

$${m}_{user} = \frac{{P}_{1} - {P}_{2}}{{P}_{1}} \qquad ( 2 )$$

S_{node} is the receiver sensitivity of the local distribution node 3 (in dBm); Sᵤₛₑᵣ is the receiver sensitivity of the user station 7 (in dBm) is the modulation index of the QCSB modulators; Aₐₜₘₒₛₚₕₑᵣₑ is the atmospheric loss (in dB); Aᵤₚ is the uplink (user station 7 to local distribution node 3) geometrical loss (in dB) which is given by:

$${A}_{atmosphere} = 20 log [ \frac{{D}_{node}}{R tan {θ}_{user}} ] dB \qquad ( 3 )$$

where D_{node} is the diameter of the receiver lens at the local distribution node 3; R is the distance between the user station 7 and the local distribution node 3 and θᵤₛₑᵣ is the beam divergence of the light beam emitted from the user station 7.

A_{telecentric} is the telecentric lens geometrical loss (in dB) which is given by:

$${A}_{telecentric} = 20 log [ \frac{{D}_{telecentric}}{R tan {θ}_{user}} ] \qquad ( 4 )$$

where

D_{telecentric} is the diameter of the telecentric lens 51.

A_{down} is the downlink (local distribution node 3 to user station 7) geometrical loss (in dB) which is given by:

$${A}_{down} = 20 log [ \frac{{D}_{user}}{R tan {θ}_{node}} ] \qquad ( 5 )$$

where Dᵤₛₑᵣ is the diameter of the receiving lens 27 of the user station 7 and θ_{node} is the beam divergence of the reflected beam output from the telecentric lens 51.

In general, for a given installation A_{telecentric}, Aᵤₚ and A_{down} are fixed losses due to the geometry of the system. The modulation index of the QCSE modulators is also a fixed parameter and hence the atmospheric loss is the only parameter that is variable. Given a measure of the atmospheric loss, equation (1) above allows the calculation of the minimum uplink modulation index (mᵤₛₑᵣ). From this calculated modulation index, the appropriate control signal (CTRL1) can be determined for application to the voltage controlled current source 221 to achieve the calculated modulation index. In this embodiment, both of these calculations are performed by controller B 237 shown in FIG. 14. As shown, in this embodiment controller B 237 calculates these solely from an input of the CTRL2 control signal and using equation (1) above.

In particular, in this embodiment the measure of the atmospheric loss (Aₐₜₘₒₛₚₕₑᵣₑ) is estimated from the current value of control signal CTRL2. This is possible because control signal CTRL2 varies with the atmospheric loss due to the action of controller A 233. In this embodiment, controller A 233 is designed so that the value of control signal CTRL2 is proportional to the atmospheric loss. The constant of proportionality relating the value of CTRL2 to the atmospheric loss can then be determined empirically (in advance) and used by controller B 237 to determine a measure of the current atmospheric loss from the current value of CTRL2. Controller B 237 then determines the minimum uplink modulation index (mᵤₛₑᵣ) in the manner discussed above and from this determines the appropriate value of control signal CTRL1 (again using control signal CTRL2 which is proportional to the transmitted laser power level P₂) which will set the maximum transmission power level P₁ at a level corresponding to the determined minimum uplink modulation index (mᵤₛₑᵣ) determined from equation (2).

Returning to FIG. 13, another aspect of the drive circuit 201 used in this embodiment is the provision of the capacitor C connected between the base of transistor Q2 and the collector of transistor Q1. In particular, capacitor C is provided in order to reduce distortion of the modulation current applied to the laser diode 17. Referring to FIG. 15, FIG. 15a is a plot showing the form of the drive current applied to the laser diode 17 generated by a laser driver identical to that shown in FIG. 13 without the capacitor C. As shown, when the transistor Q1 opens and closes, spikes 241 are generated in the drive current applied to the laser diode 17.

The inventor has identified that these spikes 241 are caused by the inherent base to collector capacitance of transistor Q1, as it couples current from the base drive signal onto the laser diode 17. The inventor has realised that this distortion can be reduced by the addition of an appropriate capacitor C connected between the base of transistor Q2 and the collector of transistor Q1. This is because the signals used to drive the bases of transistors Q1 and Q2 are 180° out of phase and therefore when a data rising edge is presented to the base of transistor Q1 a corresponding falling edge is presented to the base of transistor Q2 and vice versa. Therefore, by setting the value of capacitor C to be substantially equal to the base to collector capacitance of transistor Q1, the current that passes through capacitor C should substantially cancel the current that passes through the base to collector capacitance of transistor Q1. FIG. 15B is a plot illustrating the drive current generated using the laser driver 201 shown in FIG. 13 with the capacitor C connected in the manner shown. As can be seen from FIG. 15B, the spikes 241 shown in FIG. 15A have been substantially suppressed. For a typical high-speed silicon transistor like those used in the present embodiment, the value of capacitor C required is approximately 1 pF.

In the first embodiment described above, a half duplex communications system was described which used QCSE devices to both detect uplink data on the received laser beam and to modulate the laser beam with downlink data, albeit in a time interleaved manner. It is possible to operate the QCSE device in both the detector and modulator modes simultaneously. FIG. 16 shows detection and modulation circuitry which may be used in such an embodiment. In particular, FIG. 16 shows a conventional transimpedance operational amplifier 141 with the electrode 89 of the QCSE device 79 being connected to its inverting input and the downlink data being input to its non-inverting input (Vᵢ). Therefore, if the slew rate and common mode rejection of the op-amp 141 are sufficient, then applying downlink modulation data to the non-inverting input of the op-amp 141 will only serve to change the reverse bias of the QCSE device 79, which will cause it to modulate the reflected light. This modulation signal will not appear on the output (V₀) of the op-amp 141. otherwise, the circuit operates as a conventional transimpedance amplifier, converting photocurrent generated by the QCSE device 79 by the incoming light into a corresponding voltage at the output of the op-amp 141.

The voltage swing at the non-inverting input (Vᵢ) needs to be held such that the QCSE device always stays in reverse bias (to achieve good photodiode action), but of large enough swing that a large modulation depth is obtained, For example, the voltage swing may be set from −5V to −10V.

In the above embodiments, retro-reflecting communications systems have been described. Whilst a number of optical modulators may be used, QCSE devices were used since these have the advantage that they can be operated at high bandwidths and can be formed in large arrays. An embodiment will now be described with reference to FIGS. 17 and 18, which provides increased bandwidth for the user terminals. In this embodiment QCSE modulators are used again for convenience. In particular, in this embodiment, each user terminal comprises two or more laser diodes which operate at different wavelengths but which use the same optical communications channel to the local distribution node. The beams generated by these diodes are combined and separated using dichroic optics.

In the embodiment shown in FIG. 17, two laser diodes 17-1 and 17-2 are provided in the user terminal. As shown, the laser beam generated by the first laser diode 17-1 is collimated by a collimator lens 21-1 and is used to carry first downlink data 14-1 from the local distribution node 3 to the user terminal 7. As shown, the collimated beam 23-1 passes through a first polarising beamsplitter 25-1 and then through a second dichroic beamsplitter 25-2 where it is optically combined with the collimated laser beam formed by the collimating lens 21-2 from the laser beam generated by the second laser diode 17-2. The laser beam generated by the second laser diode 17-2 is used to carry second downlink data 14-2 from the local distribution node 3 to the user terminal 7. A third polarising beamsplitter 25-3 is also provided between the collimator lens 21-2 and the beamsplitter 25-2. The combined laser beam then passes through a λ/4 wave plate 111 which changes the polarisation of the beam from linear to circular. The combined laser beam from the beamsplitter 25-2 is then expanded through an optical beam expander 27 comprising a concave lens 113 and a collimating lens 115. The expanded laser beam 15 output by the optical beam expander 27 is directed towards the local distribution node 3.

In this embodiment, the local distribution node has a similar structure to the local distribution node shown in FIG. 10, except that the array of detectors 121 in this embodiment is a second array of QCSE devices like array 53. The QCSE device is a wavelength sensitive device. FIG. 18 shows a typical response curve (ie its reflectivity) for the device as a function of wavelength. The particular response curve can, however, be selected at the time of manufacture. Therefore, in this embodiment, the two arrays of QCSE devices 53 and 121 are arranged to be matched to a respective one of the laser diode wavelengths. A dichroic beamsplitter 54 is then used to split the beams from the two diodes onto the corresponding array, where they are modulated with the downlink modulation data 14-1 and 14-2 and reflected back to the user terminal via the beamsplitter 54.

At the user terminal, the reflected beam is collected by the beam expander 27 which concentrates the reflected beam into a smaller diameter beam. This concentrated beam then passes back through the λ/4 wave plate 111 which converts the polarisation of the light back into linear polarisation. However, because of the reflection at the retro-reflector, the reflected beams will have a linear polarisation that is 90° rotated relative to the transmitted beams. The combined beams are then separated by the dichroic beamsplitter 25-2 and the reflected beam from diode 17-1 is reflected by the polarising beamsplitter 25-1 towards the lens 31-1 and the photodiode 29-1, whilst the reflected beam from diode 17-2 is reflected by the polarising beamsplitter 25-3 towards the lens 31-2 and the photo-diode 29-2. The signal generated by the photodiode 29-1 is used to retrieve the first downlink data 14-1 and the signal generated by the photodiode 29-2 is used to retrieve the second downlink data 14-2. The bandwidth available between the user terminal and the local distribution node is therefore doubled because of the additional laser beam which can carry data. As those skilled in the art will appreciate, in the general embodiment where there are n diodes operating at different wavelengths within the user terminal, the bandwidth available will be increased by a factor of n over the single diode system.

In the above embodiments, an array of QCSE modulators were used in the retro-reflecting end of the communications link. These OCSE modulators either absorb or reflect incident light. As those skilled in the art will appreciate, other types of reflectors and modulators can be used. For example, a plane mirror may be used as the reflector and a transmissive modulator (such as a liquid crystal) may be provided between the lens and the mirror. Alternatively still, beamsplitters may be used to temporarily separate the path of the incoming beam from the path of the reflected beam and, in this case, the modulator may be provided in the path of the reflected beam so that only the reflected light is modulated. However, such an embodiment is not preferred since it requires additional optical components to split the forward and return paths and then to recombine the paths after modulation has been effected.

In the above embodiments, a telecentric lens was used in front of the array of retro-reflectors. Whilst the use of a telecentric lens is preferred, it is not essential. Further, if a telecentric lens is used, the back focal plane of the lens may be curved or partially curved, in which case the array of modulators should also be curved or partially curved to match the back focal plane of the telecentric lens.

In the above embodiments, the local distribution node and the user stations had a single optical system and used a beam splitter to separate the uplink and downlink signals. In an alternative embodiment, separate optical systems may be provided in the user station for the light emitter and the light detector to reduce back reflections falling on the light detector. Similarly, separate optical systems may be provided in the local distribution node for the modulator and the light detector. The applicants' earlier International application PCT GB01/03113 describes a retro-reflecting system using such separate optical systems.

In the embodiment described above with reference to FIGS. 11 to 15, two control loops were used to control the drive current applied to the laser diode and one of the control signals was used to determine a measure of the atmospheric losses for use in the second control loop. As those skilled in the art will appreciate this is not essential. The measure of the atmospheric losses may be derived or obtained from an alternative source. For example, a camera may be provided which generates image signals of the communication link between the user station and the local distribution node. In this case, appropriate image processing circuitry could be provided to process the image signals from the camera to derive an appropriate measure for the atmospheric loss. However, as those skilled in the art will appreciate, such an embodiment is not preferred because of the additional complexity and circuitry required to-determine the measure of the atmospheric loss.

In the embodiment described with reference to FIGS. 11 to 15, a closed control loop was formed between the user station and the local distribution node using the retro-reflected optical beam generated at the user station. This control loop was used in order to try to maintain the dynamic range of variation of the reflected signal level at a predetermined level which allows the receiver electronics to be able to recover the down link data. The measured signal used in the control loop was the average power level of the received signal. As those skilled in the art will appreciate, other measures may be used, such as the average signal to noise ratio. Further, in that embodiment, the set point of the desired power level was fixed in advance. In an alternative embodiment a mechanism may be provided to vary the set point either in response to a user input or automatically in response to historical performance data that can be analysed off-line. Further, in that embodiment discussed above, the laser control unit monitored the average power level of the AC component of the received signal. Since the retro-reflected beam also includes a DC component, the laser control unit could instead or in addition monitor the DC component of the received signal to determine the appropriate CTRL2 control signal.

In the embodiment described above with reference to FIGS. 11 to 15, p-n-p type transistors were used in the laser drive circuit. As those skilled in the art will appreciate, n-p-n type transistors or any other solid state switch may be used instead.

In the above embodiments, a multipoint to point signalling system has been described. As those skilled in the art will appreciate, many of the advantages of the systems described above will also apply to point to point signalling systems, to point to multipoint signalling systems and to multipoint to multipoint signalling systems.

1. An optical signalling system comprising first and second signalling devices,
the first signalling device comprising means for receiving an optical signal transmitted from said second signalling device and carrying uplink data transmitted from said second signalling device; an optical to electric converter for converting a portion of the received optical signal into a corresponding electric signal; means for processing the corresponding electric signal to retrieve said uplink data; means for modulating a portion of the received optical signal with downlink modulation data for the second signalling device and for reflecting the portion of the received optical signal back to the second signalling device; and
the second signalling device comprising means for generating an optical signal; means for modulating the generated optical signal with said uplink data for the first signalling device; means for outputting the optical signal towards said first signalling device; means for receiving the reflected optical signal from said fist signalling device carrying said downlink data; and means for retrieving the downlink data from said reflected signal;
characterised in that said modulating and reflecting means also acts as said optical to electric converter.

2. A system according to claim 1, wherein said modulating, reflecting and optical to electric converting means comprises a Quantum Confined Stark Effect device.

3. A system according to claim 1, wherein said first and second signalling devices are operable to transmit said uplink data and said downlink data in a time multiplexed manner.

4. A system according to claim 3, wherein said modulation, reflection and optical to electric converting means comprises an electrode which is connected, via a switch, to said processing means and to a bias voltage generator which is operable to generate a bias voltage in dependence upon the downlink data to be transmitted to said second signalling device, and wherein said time multiplex Communication is controlled by controlling the position of said switch.

5. A system according to claim 1, wherein said first and second signalling devices are operable to modulate different characteristics of said optical signal.

6. A system according to claim 5, wherein said first and second signalling devices are operable to transmit said uplink data and said downlink data simultaneously.

7. A system according to claim 6, wherein said modulation, reflection and optical to electric converting means comprises an electrode which is connected to an inverting input of a transinpedence amplifier and wherein the non-inverting input of said transinpedence amplifier is connected to a bias voltage generator which is operable to generate a bias voltage in dependence upon the downlink data to be transmitted to said second signalling device and wherein the output signal from said transinpedence amplifier varies in dependence upon the uplink data transmitted from said second signalling device.

8. An optical signalling system comprising first and second signalling devices,
the first signalling device comprising means for receiving an optical signal transmitted from said second signalling device and carrying uplink data transmitted from said second signalling device; an optical to electric converter for converting a portion of the received optical signal into a corresponding electric signal; means for processing the corresponding electric signal to retrieve said uplink data; means for modulating a portion of the received optical signal with downlink modulation data for the second signalling device and for reflecting the portion of the received optical signal back to the second signalling device; and
the second signalling device comprising means for generating an optical signal; means for modulating the generated optical signal with said uplink data for the first signalling device; means for outputting the optical signal towards said first signalling device; means for receiving the reflected optical signal from said first signalling device carrying said downlink data; and means for retrieving the downlink data from said reflected signal;
characterised in that said second signalling device comprises:
first and second generating means for generating first and second optical signals;
means for combining the first and second optical signals output by said first and second generating means;
wherein said modulation means of said second signalling device is operable to modulate said first optical signal; and
wherein said first signalling device is arranged so that the first optical signal carrying said uplink data is directed onto said optical to electric converter means and so that said second optical signal is directed onto said modulating and reflecting means.

9. A system according to claim 8, wherein said first and second generating means are operable to generate optical signals having a different polarisation state and wherein said first signalling device comprises a polarising beamsplitter for splitting the first and second optical signals.

10. A system according to claim 8, wherein said second signalling device further comprises means for changing the polarisation state of at least one of the generated optical signals and wherein said first signalling device comprises means for splitting the received first and second optical signals.

11. A system according to claim 8, wherein said first and second generating means are operable to generate optical signals having different wavelengths and wherein said first signalling device comprises a wavelength sensitive beamsplitter for separating the optical signals from the first and second generating means.

12. A system according to claim 8, wherein said second signalling device further comprises means for converting the polarisation of the combined optical signal to circular polarisation and for converting the circular polarised reflected light back to linear polarised light and further comprises a polarising beamsplitter for separating the reflected signal from the transmitted signal.

13. An optical signalling system comprising first and second signalling devices,
the first signalling device comprising means for receiving an optical signal transmitted from said second signalling device; means for modulating the received optical signal with modulation data for the second signalling device and for reflecting the received optical signal back to the second signalling device; and
the second signalling device comprising means for generating an optical signal; means for outputting the optical signal towards said first signalling device; means for receiving the reflected optical signal from said first signalling device carrying said modulation data; and means for retrieving the modulation data from said reflected signal;
characterised in that said second signalling device comprises:
first and second generating means for generating first and second optical signals having different wavelengths;
means for combining the first and second optical signals output by said first and second generating means;
in that said first signalling device comprises:
a wavelength sensitive beamsplitter for splitting said first and second optical signals; and
wherein said modulating and reflecting means comprises a first modulation and reflecting means for modulating and reflecting the first optical signal with first modulation data and second modulation and reflecting means for modulating the second optical signal with second modulation data; and
wherein said second signalling device further comprises a wavelength sensitive beamsplitter for separating the reflected first and second optical signals and wherein said retrieving means comprises first and second retrieving means for retrieving the first and second modulation data respectively.

14. A system according to claim 13 wherein said second signalling device further comprises means for converting the polarisation of the combined optical signal to circular polarisation and for converting the circular polarised reflected back to linear polarised light and further comprises a polarising beamsplitter for separating the reflected signal from the transmitted signal.

15. A system according to claim 13, wherein said first and second modulating and reflecting means comprises a Quantum Confined Stark Effect device.

16. A system according to claim 1, wherein said first signalling device further comprises focussing means for focussing the received optical signal onto said reflecting means.

17. A system according to claim 16 wherein said focussing means comprises a telecentric lens and wherein said reflecting means is located substantially at the focal plane of said lens.

18. A system according to claim 17 wherein said telecentric lens is a wide angled telecentric lens.

19. A system according to claim 16
wherein said modulating means is transmissive and is located between said focussing means and said reflecting means.

20. A system according to claim 1, wherein said modulating means and said reflecting means are co-located.

21. A system according to claim 1
wherein said modulating means and said reflecting means are separate elements.

22. A system according to claim 1, wherein said first signalling device comprises a plurality of modulating and reflecting means for modulating and reflecting optical signals received from a plurality of second signalling devices.

23. A system according to claim 22 wherein said plurality of modulating and reflecting means are arranged in an array.

24. A system according to claim 23 wherein said plurality of modulating and reflecting means are arranged in a regular array.

25. A system according to claim 24 wherein said plurality of modulating and reflecting means are arranged in a two dimensional array.

26. A system according to claim 1, wherein said reflecting means comprises a retro-reflector.

27. A system according to claim 1, wherein said modulating means is operable to modulate at least one of the amplitude, phase, frequency or polarisation of the received signal.

28. A system according to claim 1, wherein said modulating means comprises a quantum confined stark effect device.

29. A system according to claim 1, wherein said second signalling device is operable to transmit a message to said first signalling device and wherein said first signalling device comprises means for retrieving the message from the received signal.

30. A system according to claim 1, wherein said generating means comprises a laser, a laser diode or a light emitting diode.

31. A system according to claim 1, wherein said second signalling device further comprises an optical beam expander for increasing the diameter of the optical signal output towards said first signalling device.

32. An optical signalling method characterised by the use of a system according to claim 1.

33. A signalling system comprising first and second signalling devices,
the first signalling device comprising a receiver for receiving a signal output from the second signalling device and carrying uplink data transmitted from the second signalling device; a converter for converting a first portion of the received signal into a corresponding electric signal; a processor for processing the corresponding electric signal to retrieve said uplink data; and a modulator and reflector for modulating a second portion of the received signal with downlink data for the second signalling device and for reflecting the second portion of the received signal back to the second signalling device; and
the second signalling device comprising a generator for generating a signal; a modulator for modulating the intensity of the generated signal between a first non-zero intensity level and a second non-zero intensity level in dependence upon said uplink data for the first signalling device; an outputter for outputting the intensity modulated signal towards said first signalling device; a first receiver for receiving the reflected signal from said first signalling device carrying said downlink data; and a data retriever for retrieving the downlink data from said reflected signal;
characterised in that said second signalling device further comprises a second receiver for receiving a signal indicative of current signal attenuation characteristics of a signalling channel between said first and second signalling devices through which said output signal and said reflected signal pass; and a controller for dynamically varying the difference in intensity between said first and second intensity levels in dependence upon the received signal indicative of the current signal attenuation characteristics of said signalling channel.

34. A system according to claim 33, wherein said modulator and reflector are formed as a single device comprising a Quantum Confined Stark Effect device.

35. A system according to claim 33 wherein said first and second signalling devices are operable to transmit said uplink data and said downlink data simultaneously.

36. A system according to claim 33, wherein said modulator of said first signalling device is operable to intensity modulate the second portion of the received signal between third and fourth non-zero intensity levels, with the difference in intensity between the third and fourth intensity levels being greater than the difference in intensity level between the first and second intensity levels.

37. A system according to claim 33, wherein said generator comprises a laser, a laser diode or a light emitting diode.

38. A system according to claim 33, wherein said second signalling device further comprises a determining unit for determining said signal indicative of the current signal attenuation characteristics of the signalling channel between the first and second signalling devices.

39. A system according to claim 38, wherein said determining unit is operable to determine said measure using a measure of the signal level of the reflected signal received back from said first signalling device.

40. A system according to claim 33, wherein said controller is operable to vary the lowest intensity level of said first and second non-zero intensity levels in dependence upon the strength of the reflected signal received back from said first signalling device.

41. A system according to claim 40, wherein said controller is operable to vary said difference in dependence upon the lowest intensity level of said first and second intensity levels.

42. A system according to claim 33, wherein said controller of said second signalling device comprises:
a first current source for generating a drive current;
a second current source for generating a bias current;
a first solid state switch having first and second main electrodes and a control electrode, the first main electrode being connected, in use, to said first current source and the second main electrode being connected, in use, to a reference potential;
a second solid state switch having first and second main electrodes and a control electrode, the first main electrode being connected, in use, to said first current source and the second main electrode being connected, in use, to said signal generator and to said second current source;
a first connector for receiving a first data signal corresponding to said uplink data and a second data signal corresponding to the inverse of said uplink data signal;
a second connector for applying said first data signal to the control electrode of said first solid state switch to open and close said first solid state switch in dependence upon the first data signal;
a third connector for applying said second data signal to the control electrode of said second solid state switch to open and close said second solid state switch in dependence upon the second data signal;
whereby the current applied in use to said signal generator corresponds to (i) the bias current provided by said second current source summed with the current from the first current source when said second solid state switch is closed; and (ii) the bias current provided by said second current source when said second solid state switch is open.

43. A system according to claim 42, wherein said controller further comprises a capacitor connected between the control electrode of said first solid state switch and the second main electrode of said second solid state switch.

44. A drive circuit according to claim 43, wherein the capacitance of said capacitor is set in dependence upon an inherent capacitance between the control electrode and the second main electrode of said second solid state switch.

45. A drive circuit according to claim 44, wherein the capacitance of said capacitor is set to be approximately equal to the inherent capacitance between said control electrode and said second main electrode of said second solid state switch.

46. A system according to claim 33, wherein said first signalling device further comprises a focussing element for focussing the second portion of the received signal onto said reflector.

47. A system according to claim 46, wherein said modulator is transmissive and is located between said focussing element and said reflector.

48. A system according to claim 33, wherein said first signalling device further comprises a focussing element for focussing the first portion of the received signal onto the convertor.

49. A system according to claim 46, wherein said focussing element comprises a telecentric lens and wherein said reflector and/or said convertor is located substantially at the focal plane of said telecentric lens.

50. A system according to claim 33, wherein said modulator and said reflector are co-located.

51. A system according to claim 33, wherein said first signalling device comprises a plurality of modulators and reflectors for modulating and reflecting optical signals received from a plurality of second signalling devices.

52. A system according to claim 51 wherein said plurality of modulators and reflectors are arranged in an array.

53. A system according to claim 33, wherein said reflector comprises a retro-reflector.

54. A system according to claim 33, wherein the data rate of said uplink data and said downlink data is substantially the same.

55. A signalling system comprising first and second signalling devices,
the first signalling device comprising a receiver for receiving a signal output from the second signalling device and carrying uplink data transmitted from the second signalling device as a small signal modulation of the output signal; a converter for converting a first portion of the received signal into a corresponding electric signal; a processor for processing the corresponding electric signal to retrieve said uplink data; a modulator and reflector for modulating a second portion of the received signal with downlink data for the second signalling device and for reflecting the second portion of the received signal back to the second signalling device; and
the second signalling device comprising a generator for generating a signal; a modulator for applying a small signal modulation to said generated signal with said uplink data for the first signalling device; an outputter for outputting the modulated signal towards said first signalling device; a receiver for receiving the reflected signal from said first signalling device carrying said downlink data; and a data retriever for retrieving the downlink data from said reflected signal;
characterised in that said second signalling device further comprises: a second receiver for receiving a signal indicative of current signal attenuation characteristics of a communications channel between said first and second signalling devices through which said output signal and said reflected signal pass; and a controller for dynamically varying a modulation depth of the small signal modulation applied to said generated signal in dependence upon the received signal indicative of the current signal attenuation characteristics of said communications channel.

56. A drive circuit for applying a drive current to a signal generator, the drive circuit comprising:
a current source for generating a drive current;
a first solid state switch having first and second main electrodes and a control electrode, the first main electrode being connected, in use, to said current source and the second main electrode being connected, in use, to a reference potential;
a second solid state switch having first and second main electrodes and a control electrode, the first main electrode being connected, in use, to said current source and the second main electrode being connected, in use, to said signal generator;
a first connector for receiving a first data signal and a second data signal, the second data signal being the inverse of the first data signal;
a second connector for applying said first data signal to the control electrode of said first solid state switch to open and close said first solid state switch in dependence upon the first data signal; and
a third connector for applying said second data signal to the control electrode of said second solid state switch to open and close said second solid state switch in dependence upon said second data signal;
whereby current from said current source passes, in use, either through said first solid state switch to said reference potential or through said second solid state switch to said signal generator in dependence upon said first and second data signals;
wherein the drive circuit further comprises a capacitor connected between the control electrode of said first solid state switch and the second main electrode of said second solid state switch.

57. A drive circuit according to claim 56, wherein the capacitance of said capacitor is set in dependence upon an inherent capacitance between the control electrode and the second main electrode of said second solid state switch.

58. A drive circuit according to claim 57, wherein the capacitance of said capacitor is set to be approximately equal to the inherent capacitance between said control electrode and said second main electrode of said second solid state switch.

59. A drive circuit according to claim 56, wherein said current source is a first current source, further comprising a second current source connected to said second main electrode of said second solid state switch and operable to apply, in use, a bias current to said signal generator, whereby the current applied in use to said signal generator corresponds to i) the bias current provided by said second current source summed with current from the first current source when said second solid state switch is closed; and ii) the bias current provided by said second current source when said second solid state switch is open.

60. A signalling system comprising first and second signalling devices,
the first signalling device comprising a receiver for receiving a signal output from the second signalling device; a modulator for modulating a portion of the received signal with modulation data for the second signalling device and for reflecting the portion of the received signal back to said second signalling device; and
the second signalling device comprising a generator for generating a signal; an outputter for outputting the generated signal towards said first signalling device; a receiver for receiving the reflected signal from said first signalling device carrying said modulation data; and a data retriever for retrieving the modulation data from said reflected signal;
characterised in that said second signalling device further comprises a processor for processing the reflected signal received at said second signalling device to derive a measure of the dynamic range of variation of the reflected signal; a comparator for comparing the derived measure with a predetermined threshold value to provide a comparison result; and a controller for dynamically varying the signal level of said generated signal in dependence upon the comparison result.

61. A signalling system according to claim 60, wherein said processor of said second signalling device is operable to process said signal to determine a measure of the signal strength of the reflected signal received at the second signalling device.

62. A system according to claim 60, wherein the reflected signal received at the second signalling device comprises a DC component and an AC component and wherein said processor comprises a filter for filtering out either the DC component or the AC component and is operable to process the filtered signal to derive said measure.

63. A system according to claim 62, wherein said filter is operable to filter out said DC component and wherein said processor is operable to derive said measure by calculating an average power level of the AC component.

64. An apparatus according to claim 60, further comprising an adjuster for adjusting the predetermined threshold value.

65. An apparatus according to claim 60, wherein said controller of said second signalling device is operable to control the transmitted signal level to be at a minimum necessary for said data retriever to be able to retrieve the modulation data from said reflected signal.

66. A signalling device comprising:
a generator for generating a signal; a modulator for varying the intensity of the generated signal between a first non-zero intensity level and a second non-zero intensity level in dependence upon uplink data to be transmitted to a remote signalling device;
an outputter for outputting the intensity modulated signal towards said remote signalling device;
a first receiver for receiving a reflected signal back from said remote signalling device carrying downlink data transmitted from the remote signalling device; and
a data retriever for retrieving the downlink data from said reflected signal;
characterised in that the signalling device further comprises a second receiver for receiving a signal indicative of current signal attenuation characteristics of a signalling channel between said signalling device and said remote signalling device through which said output signal and said reflected signal pass; and a controller for dynamically varying the difference in intensity between said first and second intensity levels in dependence upon the received signal indicative of the current signal attenuation characteristics of said signalling channel.

67. A signalling device comprising:
a generator for generating a signal;
an outputter for outputting the generated signal towards a remote signalling device;
a receiver for receiving a reflected signal from said first signalling device carrying modulation data; and
a data retriever for retrieving the modulation data from said reflected signal;
characterised in that said signalling device further comprises a processor for processing the reflected signal to derive a measure of the dynamic range of variation of the reflected signal;
a comparator for comparing the derived measure with a predetermined threshold value to provide a comparison result; and
a controller for dynamically varying the signal level of said generated signal in dependence upon the comparison result.

68. An optical signalling method characterised by the use of a signalling system according to claim 33,

69. An optical signalling method characterised by the use of a signalling device according to claim 66.

70. An optical signalling method characterised by the use of a signalling device according to claim 67.
